(19) United States
(12) Patent Application Publication
(10) Pub. No.: US 2026/0084161 A1
(43) Pub. Date: Mar. 26, 2026

(54) Agitator Mill Having Special Drivers

(71) Applicant: NETZSCH-Feinmahltechnik GmbH, Selb (DE)

(72) Inventors: Witali Sudermann, Selb (DE); Holger Möschl, Selb (DE)

(21) Appl. No.: 19/109,728

(22) PCT Filed: Aug. 24, 2023
(86) PCT No.: PCT/EP2023/073208

§ 371 Date: Mar. 7, 2025

(30) Foreign Application Priority Data
Sep. 8, 2022 (DE) 10 20220122 868.1

(51) Int. Cl. B02C 17/16

(52) U.S. Cl. CPC B02C 17/163; B02C 2017/165

(57) ABSTRACT

An agitator mill, in particular in the form of a full-volume disk mill, with a grinding container, an agitator shaft circulating therein about a horizontal axis, which carries several grinding disks, which are connected thereto in a rotationally fixed manner and which are spaced apart from one another in the direction of the horizontal axis, wherein the grinding disks each have slots or apertures, wherein the agitator mill has drivers in the region between two grinding disks, which drivers circulate synchronously with the grinding disks during grinding and which provide a movement component in the radially outwards direction to at least a portion of the grinding bodies, which come into contact with them, in that they displace these grinding bodies directly in response to the circulation thereof, preferably in the radial direction.

### TECHNICAL FIELD

The invention relates to an agitator mill with drivers according to the claims.

### BACKGROUND

The basic principle of an agitator mill will initially be explained on the basis of FIG. 1.

An agitator mill 1 with horizontal agitator shaft 3 is illustrated schematically in FIG. 1. The illustration of the grinding bodies, which are located in the grinding container 2 and which are generally embodied as steel or ceramic balls, was forgone.

During the operation of the agitator mill 1, the material to be ground is pumped via the inlet 101 of the agitator mill 1 into or through the grinding space 14, respectively, which is enclosed by the grinding container 2. In the case of wet grinding, the material to be ground is a suspension or dispersion, respectively, of a liquid, usually in the form of water, and solids. In other cases, such an agitator mill 1 can also be used for dry grinding. It can then be designed, for instance, as agitator mill with vertical shaft, by means of which the grinding material is carried through by a gaseous fluid, usually in falling flow.

According to its broadest aspect, the present invention relates to both types of agitator mills. Its use in agitator mills with horizontal agitator shaft 3 is particularly preferred.

Due to a rotational movement of the agitator shaft 3 about the agitator shaft axis 6, the grinding members, which are connected in a rotationally fixed manner to the agitator shaft 3 and which are often also embodied and referred to as grinding disks 4, are set in rotation. The formation of the grinding members in the form of individual pins is likewise possible, also in the context of the invention, which will be described right away. In the context of the invention, however, the use of grinding disks is preferred, which is why only “grinding disks” will be mentioned below and only grinding disks of this type will be shown as grinding members. To generate the rotational movement, the agitator shaft 3 can be driven by an electric motor, for example via a belt drive. The drive of the agitator mill 1 is thereby usually located in a housing adjoining the grinding container 2. For the sake of clarity, the drive as well as the housing are not shown in FIG. 1.

Due to the rotation of the grinding disks 4, the grinding bodies located in the grinding space 14,which are located in the vicinity of the grinding disks 4, are entrained in the circumferential direction of the grinding container 2. As soon as they have reached the apex region, the moved grinding bodies flow back again in the direction of the agitator shaft 3 in the central region between two grinding disks 4. A circulation movement of the grinding bodies is thus created between two grinding members or grinding disks 4, respectively. This circulation movement is illustrated schematically in FIG. 1 by means of two dashed arrows (line with dash and two dots) in an exemplary manner for the free space between the first and second grinding disk 4 (viewed from the inlet 101 and only in the upper region of the sectional view of the agitator mill 1).

Collisions and overrolling motions between the solids of the grinding material suspension pumped through the grinding container 2 and the grinding bodies are caused due to the movement of the grinding bodies. These collisions and overrolling motions lead to the chipping of fine particles from the solids in the grinding material suspension, so that the solids arriving at the outlet 102 of the agitator mill 1 are ultimately significantly smaller than the solids supplied at the inlet 101.

In order to ensure that grinding bodies are not discharged from the grinding space 14, a screen 103 is usually also attached in front of the outlet 102 and/or carried by the outlet 102. A basket 104 engaging around this screen is attached around this screen 103. The basket serves the purpose of preventing that the grinding bodies, which tend to be pushed in the direction of the screen due to the pressure of the feed pump, exert detrimental grinding body pressure on the screen.

Such agitator mills and in particular full-volume disk mills, as shown in FIG. 1, are characterized in that voluminous free spaces are formed between the directly adjacent grinding disks 4,which free spaces—as mentioned—are filled essentially with grinding bodies. A full-volume disk mill of this type is present in particular when grinding disks are used as grinding members and when the inner diameter D_{B} of the grinding container 2 is equal to or greater than 2.5-times the diameter D_{W} of the agitator shaft 3. The outer diameter of the agitator shaft 3 in the region between two adjacent grinding disks 4 is understood as diameter D_{W} here.

Due to the corresponding packing density, the grinding bodies remain essentially in their region between two grinding disks 4, even if gaps or apertures can be encountered, which, by nature, would allow a transition of a grinding body from a region between two grinding disks 4 into an adjacent region between two grinding disks 4.

A fluid is pumped from the inlet 101 of the agitator mill 1 all the way to the outlet 102 thereof through the intermediate spaces between the grinding bodies. A feed pump is used for this purpose. The feed pump flow of this fluid carries the material to be ground through the agitator mill 1.

In response to the rotation of agitator shaft 1 and of the grinding disks 4 connected thereto, the grinding bodies are ultimately also entrained not least due to the friction at the grinding disks 4.As mentioned, they thus circle in the circumferential direction. They roll on one another, on the grinding container 2 and on the grinding disks 4 in a grinding manner thereby. The grinding material is comminuted, thus ground, especially due to the pulse effect of grinding bodies, which move towards one another and then about one another and due to said grinding effect.

The problem thereby arises again and again that the grinding bodies do not move sufficiently dynamically in the free space between the two adjacent grinding disks 4 or do not move sufficiently strongly, respectively, in the radial vicinity of the agitator shaft 3 of all places, in which the feed pump tries to form a transverse flow, and/or that the circulation movement of the grinding bodies does not get close enough to the radial vicinity of the agitator shaft 3.

This then has the result that the fluid, which comes from the feed pump, and which carries the grinding material, passes through one free space after the other between two adjacent grinding disks 4 via the shortest route, instead of first gradually circling for a while in each case in each free space between two grinding disks 4. This then leads to a so-called leading. In the case of a leading, the grinding material does not have a sufficiently intensive contact with the grinding bodies. It is thus ground only inadequately. The schematic movement of the grinding material in response to a “leading” of this type, is illustrated schematically, in turn, in FIG. 1 by means of a curved arrow in an exemplary manner for the movement from the inlet 101 over the free space between the first and second grinding disk 4 (viewed from the inlet 101 and only in the upper region of the sectional view of the agitator mill 1).

The problem of leading is particularly precarious in the case of full-volume disk mills because the towering free space between two adjacent grinding disks 4 in the case of such agitator mills notably tends to not generate a sufficient grinding body movement.

### SUMMARY

In light of the aforementioned, the object is to create an agitator mill with further improved grinding effect.

According to the invention, this problem is solved with the features of the first main claim.

For this purpose, an agitator mill is proposed, in particular in the form of a full-volume disk mill, with a grinding container and an agitator shaft circulating therein about a horizontal axis. The agitator shaft hereby carries several grinding disks, which are connected thereto in a rotationally fixed manner, and which are spaced apart from one another in the direction of the horizontal axis, wherein the grinding disks each have slots or apertures. As already explained above, a full-volume disk mill of this type is present at least when grinding disks are used as grinding members and when the inner diameter D_{B} of the grinding container is equal to or greater than 2.5-times the diameter D_{W} of the agitator shaft. The outer diameter of the agitator shaft in the region between two adjacent grinding disks is understood here as diameter D_{W}.

The agitator mill according to the invention is characterized in that it has drivers in the region between two directly adjacent grinding disks, which drivers circulate synchronously with the grinding disks during grinding. These drivers additionally provide a movement component in the predominantly or in the essentially radially outwards direction to at least a portion of the grinding bodies, which come into contact with them, in that they displace these grinding bodies directly in response to the circulation thereof, preferably in the predominantly or in the essentially radial direction. After colliding with the driver, the movement vector of a grinding body, which is caused locally in each case, thus has a movement component in the radially outwards direction, which accounts for at least 60%, preferably at least 75%, of the total movement vector. It is important to point out explicitly once again hereby, however, that this does not apply for each grinding body after a collision with the driver but in fact only for at least a portion. How many grinding bodies do in fact collide with the driver depends on many factors, such as the design of the driver, the conveying speed, the size of the grinding bodies, the grinding material, etc.

A pulse is thus preferably delivered to the respective grinding body, which has the result that the respective grinding body, in turn, transmits a pulse to at least one grinding body, which comes into contact with the respective grinding body. This grinding body, in turn, then also transmits a pulse to grinding bodies, which collide with said grinding body. This thus results in a pulse sequence, the origin of which lies in the pulse transmission from the driver to grinding bodies, which come into contact with the driver.

This movement component caused hereby for at least a portion of the grinding bodies especially in the radially outwards direction has the result that an improved circulation of the grinding bodies is attained. Especially the grinding bodies in the vicinity of the agitator shaft are additionally, also activated here, whereby the described circulation movement of the grinding bodies comes closer to the circulating surface of the agitator shaft.

The grinding space, which is effectively used for the grinding effect, is thus generally increased and/or the grinding effect on the material to be ground is increased. The number of leadings is additionally increased because an increased movement of the grinding bodies in the entire grinding space radially outside of the agitator shaft is ensured, whereby an improved entraining of the material to be ground can be determined.

There are a number of options for designing the invention so that its effectiveness or usability is even further improved.

A particularly preferred embodiment is that a driver has at least one section with a surface profile, which is non-circular—with regard to the horizontal axis of the agitator shaft—which forms a pulse generator, by means of which the grinding bodies are displaced in response to the circulation of the driver. This “non-circular surface profile” is preferably attained in that several flattenings are preferably provided on the driver. These flattenings are preferably formed so that they at least partly flatten an otherwise round cross-section in the region of its circumference. It is important to mention hereby that a driver can also be designed in such a way that so many flattenings are attached over the circumference of a driver at least in sections that respective cross-sections do not have any round regions at all any longer. These flattenings are preferably formed as flat surfaces and can additionally be formed so that they run parallel to the longitudinal axis of the driver and thus to the agitator shaft axis or also have a certain angle of attack with respect to the longitudinal axis of the driver. The flattened surfaces of a bushing thus effectively act as pulse generator and are thereby only exposed to a decreased wear on their own. It is additionally important to mention in general that not each section, which has a “non-circular surface profile”, has to simultaneously also act as pulse generator.

It is furthermore particularly preferred that the drivers are bushings, which engage over the agitator shaft in the free region between the grinding disks or which are formed integrally in this region by means of the agitator shaft or which are an integral part, which protrudes on the front side, of at least one grinding disk, wherein a single bushing in terms of one of the above-mentioned alternatives preferably in each case lies between two directly adjacent grinding disks. It can thus be ensured that the drivers can be attached in a simple way (easy to assemble and without large manufacturing effort) at its intended position between the grinding disks. The preferred embodiment of the driver hereby preferably represents the embodiment as external bushing, which encloses the agitator shaft at least in the region between two adjacent grinding disks. Due to the fact that this embodiment represents the clearly preferred embodiment, reference will only still be made below to drivers in bushing form, which is why only the term “bushing” is used. It is important to emphasize hereby, however, that drivers in other embodiment can also have design features of this type, which will be mentioned below. Due to the fact, however, fact that the bushing shape represents the clearly preferred embodiment, it will preferably be described simplistically below as “bushing” in order to simplify the “drivers, preferably in the form of a bushing”.

A further preferred embodiment lies in that bushings in each case have the initial shape of a body with polygonal cross-section, preferably with square cross-section, which has a taper between its front sides at least in sections, the cross-section of which has a smaller circumference than the polygonal cross-section of the initial shape.

On the one hand, this has manufacturing advantages because it is preferred that the bushings represent polygonal bodies, which are partly twisted. The above-mentioned “non-circular surface profiles” or flattenings, respectively, can furthermore be easily provided on the bushings. For example, a region from the respective front side of the bushing all the way to a circumferential reduction as intended without processing the bushing can thus be maintained, which region then already forms various pulse generators integrally due to its “angular”, polygonal basic shape. The mentioned taper is furthermore provided on the bushing, so that the grinding bodies can reach closer to the original agitator shaft. The grinding space is thus increased once again and—as described above—a desired circulation movement of the grinding bodies all the way to the vicinity of the agitator shaft surface can form over a large region.

This taper furthermore has various advantages especially in combination with the mentioned flattenings. This is so because especially those flattened surfaces, which extend next to the taper into the edge regions with the larger diameter, have a special blade effect thereby.

It is additionally particularly preferred when the cross-section of the taper at least predominantly represents a circle, preferably with a diameter, which remains constant over the length of the taper. On the one hand, this can be realized more easily from a manufacturing aspect and due to the fact that the agitator shaft preferably likewise has a circular cross-section, it can thus be ensured on the other than that the grinding bodies can be guided equally close to the agitator shaft surface over the entire circumference of the bushing. The design of the taper additionally has a significant impact on the flow behavior of the grinding bodies. In the case of a circular embodiment, for example, the taper leads to virtually no pulse effect whatsoever radially to the outside. No noteworthy counter movements to the desired grinding body movement in the direction of the shaft axis are thus created, and the circling movement of the grinding bodies in the center between two grinding disks towards the bushing is not slowed down. The grinding bodies can thus also flow unhindered into the region close to the shaft and a grinding body-free space is not created close to the shaft. Fewer leadings generally occur hereby.

It is furthermore particularly preferred when the transitions between the respective front sides and/or front side sections and the taper are inclined, preferably conically or spherically. The grinding bodies circulating in the region between the grinding disks are hereby prompted to flow towards the shaft axis, i.e., to move more strongly into the region of the center between two grinding disks again, for example as part of their downwards movement, which intensifies the circling of the grinding bodies in the free region between two grinding disks.

A “front side section” is present when—as already mentioned—the initial cross-section of the front side is in each case still maintained in sections up to a certain circumferential reduction towards the bushing center.

A further preferred embodiment is that the taper of the bushings is bordered with respect to the pulse generators by means of a surface, which is curved in such a way that it does not form a pulse generator even in response to rotation of the bushing. The “blade effect” of the bushing can thus be set via the ratio of surface area of the taper to surface area of the pulse generators, i.e., the intensity of the pulse generator formed with this bushing or how strongly said pulse generator displaces the grinding bodies, respectively.

It is furthermore particularly preferred that, in the region of their taper, preferably in the transition region between taper and front side and/or between taper and front side section, the bushings have inclined surfaces, which are designed in such a way that a movement, which runs predominantly or essentially in the circumferential direction of the agitator shaft, is forced upon the grinding bodies by said inclined surfaces especially by means of the rotation of the bushings. Coming from the center between two grinding disks, the grinding bodies are thus deflected close to the shaft in the direction of the grinding disk and are then moved radially outwards from the inclined surfaces in the direction of the grinding disk wall, in order to support the “friction support” of the grinding disk wall and to accelerate the grinding bodies there. The grinding bodies are thereby increasingly made to circle in the region of the free space between two directly adjacent grinding disks and/or to perform the self-rotation around themselves, which increases the grinding effect in each case.

It is furthermore particularly preferred when the taper of the bushings is free, i.e., completely free or essentially free, from pulse generators. A controlled influence of the “blade effect” of the bushings can thus be realized. Even if the respective taper is cut by the flattenings, the pulse-giving effect of the section in the region of the tapers is negligibly small compared to the pulse generators.

A further preferred embodiment is that the pulse generators are predominantly or even completely, namely absolutely completely or essentially completely, arranged in the vicinity of the grinding disk front sides, said vicinity preferably accounts for less than or equal to ¼ of the distance between two directly adjacent grinding disks-measured in the direction of the horizontal axis of the agitator shaft. A preferred circulation movement of the grinding bodies is thus attained.

It is additionally particularly preferred when the grinding disks have at least one, better several, apertures, through which the grinding bodies can reach from an intermediate space between two grinding disks into the adjacent intermediate space between two grinding disks. An “aperture” can be a window bordered on all sides or a slot protruding inwards from the largest outer radius. These apertures provide for a passing of the material to be ground from the inlet to the outlet of the agitator mill.

A further preferred embodiment is that flow breakers are arranged between the grinding disks, which protrude from the grinding container inner surface into the free region between two grinding disks, preferably directly above the taper of the bushings, ideally in the region of the center thereof. These flow breakers are usually pins, which ideally—viewed in the circumferential direction—are provided so as to be aligned one behind the other, so that they do not or not significantly slow down the circulation of the grinding bodies in the circumferential direction.

It is furthermore possible that the flow breakers—preferably viewed in the circumferential direction—are arranged asymmetrically, i.e., lie closer to the one grinding disk than to the other grinding disk in the intermediate space between two directly adjacent grinding disks. Apart from that, the statements made above apply. Depending on the shape of the bushing, the flow breakers and the described arrangement thereof, in turn, lead to the preferred flow of the grinding bodies in the region between two adjacent grinding disks. The flow breakers thus cause a “loosening” of the ball packet, which the grinding bodies form. Due to the centrifugal force of the rotating agitator shaft, this “ball packet” tends to densify on the container wall. A ball packet of such a density moves only slowly and thus offers only little collision energy for grinding purposes. The flow breakers loosen the ball packet accordingly and the circling movement of the grinding bodies is additionally accelerated by means of this loosening.

### BRIEF DESCRIPTION OF THE DRAWINGS

FIG. 1 shows an agitator mill according to the prior art in cut side view, whereby the grinding body flow (arrows with line with dash and two dots) and the flow of the grinding material (curved arrow with solid line) are illustrated schematically.

Analogously to FIG. 1, FIG. 2 shows an agitator mill according to the invention in cut side view with a first exemplary embodiment of the bushings and resulting grinding body flow (arrows with line with dash and two dots).

Analogously to FIG. 2, FIG. 3 shows an agitator mill according to the invention in cut side view with a second exemplary embodiment of the bushings and resulting grinding body flow (arrows with line with dash and two dots).

FIG. 4 shows the second exemplary embodiment of a bushing according to the invention from FIG. 3 in three-dimensional view.

FIG. 5a shows a third exemplary embodiment of a bushing according to the invention in side view and FIG. 5b shows the three-dimensional view of this exemplary embodiment.

FIG. 6a shows a fourth exemplary embodiment of a bushing according to the invention in three-dimensional view, FIG. 6b shows this exemplary embodiment in front view and FIG. 6c shows this exemplary embodiment in side view.

FIG. 7a shows a fifth exemplary embodiment of a bushing according to the invention in three-dimensional view, FIG. 7b shows this exemplary embodiment in front view and FIG. 7c shows this exemplary embodiment in side view.

FIG. 8a shows a sixth exemplary embodiment of a bushing according to the invention in three-dimensional view, FIG. 8b shows this exemplary embodiment in front view and FIG. 8c shows this exemplary embodiment in side view.

### DETAILED DESCRIPTION

FIG. 1 initially shows the prior art, whereby said prior art has already been described in more detail above in the paragraph “Technical Background”. For this reason, this FIG. 1 will not be explained in more detail here. However, it is important to point out once again that a desired mixing of the grinding bodies in the region between two adjacent grinding disks 4 does not occur in the case of an agitator mill 1 embodied in this way. Even though the grinding bodies carry out a desired circulation movement (see arrows with lines with dash and two dots), this circulation movement is not sufficiently dynamic and does not reach all the way into the vicinity of the agitator shaft 3, which is why “leadings” occur especially in this region. This means that the grinding material does not stay long enough in the region between two adjacent grinding disks 4 and does not perform or only partly performs the circulation movement and thus does not experience the desired grinding effect, before it “leads” directly into the adjoining region between two grinding disks 4 through apertures in the grinding disk 4. To simplify matters, the respective space between two adjacent grinding disks 4 is furthermore referred to only as “grinding chamber”, whereby these “grinding chambers” are thus part of the entire grinding space 14.

Analogously to FIG. 1, FIG. 2 now shows an agitator mill 1 according to the invention with drivers, which are designed in accordance with the invention. For better visualization, the illustration of the grinding bodies and of the grinding material as well as of the driving parts of the agitator mill 1 was also foregone here, in turn.

Here and also in the further figures, the drivers are embodied as bushings 8, which enclose the agitator shaft 3 at least between two adjacent grinding disks 4 and which are preferably pushed onto ledges of the agitator shaft. The agitator shaft 3 is thus preferably enclosed completely by the bushings 8 in these regions. In this and all further figures, the drivers are shown in the form of bushings 8, which will, in turn, only be referred to as “bushings” below in order to simplify matters. The exact design of these bushings 8 will be discussed in more detail hereinafter.

The attachment of the bushings 8 between the grinding disks 4 and the formation of the grinding chamber radially outside of the bushings 8 can thus be recognized in FIG. 2. The circulation movement of the grinding bodies (arrows with line with dash and two dots) is additionally shown, in turn, in an exemplary manner and schematically in a grinding chamber. On the one hand, said circulation movement is significantly more dynamic (not illustrated) than the circulation movement from FIG. 1, but this circulation movement runs especially closer to the surface of the bushing 8—compared to the equivalent agitator shaft surface of FIG. 1.

A desired, dynamic circulation movement of the grinding bodies thus forms especially together with the flow breakers 12, which are designed as protrusions protruding radially inwards and which are preferably formed in the form of pins, which are periodically attached to the inner wall of the grinding container 2 in a circumferential manner.

Fewer leadings thus occur because the grinding material remains in the respective grinding chamber for a longer period of time and is rather entrained by this circulation movement. An additional grinding effect on the grinding material can thus be attained. This is suggested schematically by means of the grinding material flow (three curved, solid arrows, which lead from the inlet 101 into the respective grinding chamber).

This desired circulation movement is in particular created in that a movement component in the radially outwards diction is provided to the grinding bodies, which collide with the pulse generators 7 of the bushing 8, in that they directly displace these grinding bodies in response to their circulation, preferably in the radial direction. These pulse generators 7 and the individual sections of the bushings 8 will be discussed in more detail later.

Analogously to FIG. 2, FIG. 3 shows the same view of an agitator mill 1, but with a second embodiment of the bushings 8. Everything is analogous to the agitator mill 1 from FIG. 2 here. The circulation movement of the grinding bodies, in turn, is illustrated with arrows with line with dash and two dots here. It can additionally be recognized here that the grinding bodies are pushed over the taper 9 or the transitions 13 adjoining the taper 9, respectively, towards the pulse generators 7. FIG. 3 additionally also shows flow arrows of the grinding material, which has the tendency of wanting to “lead” close to the shaft, thus, to skip a grinding space in an unground state or in a state, which is not as strongly ground as desired. It becomes clear here that even though certain parts of the grinding material are mixed into the circling movement of the grinding bodies, various leadings are also created, which is to be prevented.

This embodiment of the bushings 8 from FIG. 3 is illustrated three-dimensionally once again in FIG. 4. The setup of such a bushing can be recognized here. Preferably, the initial body or base body of the bushing 8, respectively, initially has a polygonal cross-section. In the example of FIG. 4, this can be considered to be an octagon or rather as square with beveled edges. A bushing 8 of this type additionally has a central through bore for mounting the bushing 8 onto the agitator shaft 3. The bushing 8 then in each case has two front sides 10. Starting at this respective front side 10 towards the center of the bushing 8, the initial basic shape is initially maintained for several millimeters, whereby a front side section 11 forms. From the respective front side section 11 towards the center, a transition region 13 forms, which is designed spherically here. In the central region of the bushing 8, this transition region 13 then transitions into the taper 9, which at least partly has a circular cross-section, in the central region of the bushing 8.

The circumference of the respective cross-sections hereby decreases continuously from the front side section 11 towards the taper 9.

This second embodiment of the bushing 8 from FIG. 4 additionally in each case has a connecting web 16 on each of the four sides, which connect the front sides 10 to one another and which bridge the taper 9.

For improved clarity, the pulse generators 7 forming in this way are illustrated in a hatched manner in FIG. 4. As mentioned, in particular these pulse generators 7 are responsible for the pulse on the grinding bodies, which acts radially outwards, while the grinding bodies are preferably guided from the taper 9 via the transition region 13 to these pulse generators 7 and/or the grinding disks 4.

In general, it is preferably the case that the respective locally caused movement vector of a grinding body, after collision with the pulse generators 7, has a movement component in the radially outwards direction, which accounts for at least 60%, preferably at least 75%, of the entire movement vector.

And after a collision with the taper 9, the respective caused movement vector of a grinding body has a movement component in the axial direction, which accounts for at least 60%, preferably at least 75%, of the entire movement vector.

A further embodiment of the bushing 8, which is illustrated in FIG. 5a and FIG. 5b, shows the fact that the taper 9 preferably does not have to be bridged by connecting webs 16 at all. In turn, the bushing 8 also has a polygonal base body here, which represents a hexagon here. This basic shape is likewise maintained for several millimeters from the respective front side 10, until the transition is made into the taper 9 via the transition region 13. The taper 9 has a circular cross-section hereby. The pulse generators 7 of the bushing 8, in turn, are illustrated in a hatched manner. The bushing axis 15 is additionally also delineated in FIG. 5a, which preferably essentially corresponds with the axis of rotation of the agitator shaft 3 in the case of manufacture and assembly as intended.

In order to simplify the assembly of the bushing 8 onto the agitator shaft 3 and in order to realize a protection against rotation with respect to the agitator shaft, the bushing 8 additionally preferably has several grooves 17, which are embodied over the entire length of the bushing 8,in the base of the central through bore. It goes without saying that, for this purpose, the agitator shaft 3 has to have thickenings, which are embodied in a complementary manner, and which can engage with these grooves 17.

A further almost identically embodied embodiment of the bushing 8 is illustrated in FIG. 6a to FIG. 6c. Compared to the preceding embodiment, however, this embodiment has an initial body with purely square initial shape.

The fact that the pulse generators 7 cannot only be formed by means of the continuation of the initial shape, becomes clear on the basis of a further embodiment of the bushing 8, which is illustrated in FIGS. 7a to 7c. The pulse generators 7 (again in a hatched manner) represent plane flattenings, which are parallel to the bushing axis 15. The original initial shape of the bushing 8 represents a square bushing hereby, which was twisted by means of a curved taper 9.

The taper 9 itself can also be only a few millimeters wide or can even represent only the connection between the transition regions 13, which touch one another in the center of the bushing 8. An embodiment designed in this way is illustrated in FIGS. 8a to 8c.

1. An agitator mill, in particular in the form of a full-volume disk mill, with a grinding container, an agitator shaft circulating therein about a horizontal axis, which carries several grinding disks, which are connected thereto in a rotationally fixed manner and which are spaced apart from one another in the direction of the horizontal axis, wherein the grinding disks each have slots or apertures, the agitator mill has drivers in the region between two grinding disks, which drivers circulate synchronously with the grinding disks during grinding and which provide a movement component in the radially outwards direction to at least a portion of the grinding bodies, which come into contact with them, in that they displace these grinding bodies directly in response to the circulation thereof, preferably in the radial direction.

2. The agitator mill according to claim 1, wherein a driver has at least one section with a surface profile, which is non-circular—with regard to the horizontal axis of the agitator shaft—which forms a pulse generator, by means of which the grinding bodies are displaced in response to the circulation of the driver.

3. The agitator mill according to claim 1, wherein the drivers are bushings, which engage over the agitator shaft in the free region between the grinding disks or which are formed integrally in this region by means of the agitator shaft or which are an integral part, which protrudes on the front side, of at least one grinding disk, wherein a single bushing preferably in each case lies between two directly adjacent grinding disks.

4. The agitator mill according to claim 1, wherein bushings in each case have the initial shape of a body with polygonal cross-section, which has a taper between its front sides at least in sections, the cross-section of which has a smaller circumference than the polygonal cross-section of the initial shape.

5. The agitator mill according to claim 4, wherein the cross-section of the taper at least predominantly represents a circle, preferably with a diameter, which remains constant over the length of the taper.

6. The agitator mill according to claim 1, wherein the transitions between the respective front sides and/or front side sections and the taper are inclined, preferably conically or spherically.

7. The agitator mill according to claim 1, wherein the taper of the bushings is bordered with respect to the pulse generators by means of a surface, which is curved in such a way that it does not form a pulse generator even in response to rotation of the bushing.

8. The agitator mill according to claim 1, wherein in the region of their taper, preferably in the transition region between taper and front side and/or between taper and front side section, the bushings have inclined surfaces, which are designed in such a way that a movement, which runs in the circumferential direction of the agitator shaft, is forced upon the grinding bodies by said inclined surfaces especially by means of the rotation of the bushings and are thereby preferably also pushed into the region of the center between two directly adjacent grinding disks.

9. The agitator mill according to claim 1, wherein the bushings are tapered so that the length of their taper is at least 45% of the distance between two directly adjacent grinding disks, in each case measured in the direction parallel to the horizontal axis of the agitator shaft.

10. The agitator mill according to claim 1, wherein at least 45% of the bushing surface facing the grinding space are free from pulse generators.

11. The agitator mill according to claim 1, wherein the taper of the bushings is free from pulse generators.

12. The agitator mill according to claim 1, wherein the pulse generators are predominantly or even completely arranged in the vicinity of the grinding disk front sides, said vicinity preferably accounts for less than or equal to ¼ of the distance between two directly adjacent grinding disks—measured in the direction of the horizontal axis of the agitator shaft.

13. The agitator mill according to claim 1, wherein the grinding disks have at least one, better several, apertures, through which the grinding bodies can reach from an intermediate space between two grinding disks into the adjacent intermediate space between two grinding disks.

14. The agitator mill according to claim 1, wherein flow breakers are arranged between the grinding disks, which protrude from the grinding container inner surface into the free region between two grinding disks, preferably directly above the taper of the bushings, ideally in the region of the center thereof.

15. The agitator mill according to claim 1, wherein the flow breakers—preferably viewed in the circumferential direction—are arranged asymmetrically, i.e., lie closer to the one grinding disk than to the other grinding disk in the intermediate space between two directly adjacent grinding disks.

16. A driver, preferably in the form of a bushing, which is arranged in the region between two adjacent grinding disks, wherein said driver circulates synchronously with the grinding disks during grinding and provides a movement component in the radially outwards direction to at least a portion of the grinding bodies, which come into contact with them, in that it displaces these grinding bodies directly in response to the circulation thereof, preferably in the radial direction.

17. A driver, preferably in the form of a bushing, which is arranged in the region between two adjacent grinding disks, wherein said driver circulates synchronously with the grinding disks during grinding and provides a movement component in the radially outwards direction to at least a portion of the grinding bodies, which come into contact with them, in that it displaces these grinding bodies directly in response to the circulation thereof, preferably in the radial direction, wherein the driver is designed to have at lease one section with a surface profile, which is non-circular—with regard to the horizontal axis of the agitator shaft—which forms a pulse generator, by means of which the grinding bodies are displaced in response to the circulation of the driver, relating to the driver and/or the bushing.

18. The agitator mill according to claim 2, wherein the drivers are bushings, which engage over the agitator shaft in the free region between the grinding disks or which are formed integrally in this region by means of the agitator shaft or which are an integral part, which protrudes on the front side, of at least one grinding disk, wherein a single bushing preferably in each case lies between two directly adjacent grinding disks.

19. The agitator mill according to claim 2, wherein bushings in each case have the initial shape of a body with polygonal cross-section, which has a taper between its front sides at least in sections, the cross-section of which has a smaller circumference than the polygonal cross-section of the initial shape.

20. The agitator mill according to claim 2, wherein the transitions between the respective front sides and/or front side sections and the taper are inclined, preferably conically or spherically.
